(19) United States
(12) Patent Application Publication
(10) Pub. No.: US 2009/0215949 A1
(43) Pub. Date: Aug. 27, 2009

(54) FLAME RETARDANT POLYCARBONATE COMPOSITIONS

(75) Inventors: Tomohide Fujiguchi, Tochigi-ken (JP); Christiaan Henricus Johannes Koevoets, Roosendaal (NL); Ying Li, Shanghai (CN); Pei Sun, Shanghai (CN)

Correspondence Address: SABIC - LEXAN;SABIC Innovative Plastics - IP Legal, ONE PLASTICS AVE., PITTSFIELD, MA, 01201-3697, US

(73) Assignee: SABIC INNOVATIVE PLASTICS IP B.V., Bergen op Zoom (NL)

(21) Appl. No.: 12/035,107

(22) Filed: Feb. 21, 2008

(51) Int. Cl. C08K 3/00; C08K 3/22; C08K 3/34

(52) U.S. Cl. 524/430; 524/451; 524/445; 524/447

(57) ABSTRACT

Blends of polycarbonate (PC) with an impact modifier, such as a butadiene-styrene based polymer like acrylonitrile-butadiene-styrene (ABS) polymers or methacrylate-butadiene-styrene (MBS) polymers, having improved flame retardance are disclosed. From about 0.5% to about 3% by weight of a filler selected from the group consisting of a clay, talc, and aluminum oxide particles are added to the blend. The resulting flame retardant polymer composition has improved flame retardance with acceptable maintenance of mechanical and/or processing properties.

### BACKGROUND

The present disclosure relates to blends of polycarbonates with impact modifiers that have increased flame retardance. Also disclosed are methods for preparing and/or using the same.

Polycarbonates (PC) are synthetic thermoplastic resins derived from bisphenols and phosgenes, or their derivatives. They are linear polyesters of carbonic acid and can be formed from dihydroxy compounds and carbonate diesters, or by ester interchange. Polymerization may be in aqueous, interfacial, or in nonaqueous solution. Polycarbonates are a useful class of polymers having many desired properties. They are highly regarded for optical clarity and enhanced impact resistance and ductility at room temperature or below.

Acrylonitrile-butadiene-styrene (ABS) and methacrylate-butadiene-styrene (MBS) polymers are synthetic thermoplastic resins made by polymerizing acrylonitrile or methacrylate, respectively, with styrene in the presence of polybutadiene. The properties of ABS and MBS can be modified by varying the relative proportions of the basic components, the degree of grafting, the molecular weight, etc. Overall, ABS and MBS are generally strong, and lightweight thermoplastics.

Blends of polycarbonates with ABS or MBS, or PC/ABS or PC/MBS blends, are also well-known. For example, SABIC Innovative Plastics provides such blends commercially under the brand name CYCOLOY®. These amorphous thermoplastic blends have many desired properties and/or characteristics, including high impact strength, heat resistance, good processability, weather and ozone resistance, good ductility, electrical resistance, aesthetic characteristics, etc. They are widely used in the automotive market, for producing appliance and electrical components, medical devices, and office and business equipment such as computer housings, etc.

However, such blends may be flammable. They can also drip hot molten material, causing nearby materials to catch fire as well. It is thus typically necessary to include flame retardant additives, such as halogenated or non-halogenated additives, that retard the flammability of the resin and/or reduce dripping. However, the inclusion of additives typically reduces the mechanical properties of the blend, resulting in reduced product lifetime and additional cost.

There is a need for PC/ABS, PC/MBS, and/or PC/ABS/MBS blends which are flame retardant when molded as thin wall articles and maintain other processing and mechanical properties, for instance, higher flow, higher heat and/or better ductility.

### BRIEF DESCRIPTION

Disclosed, in various embodiments, are blends of polycarbonates (PC) with impact modifiers, such as butadiene-styrene polymers, including acrylonitrile- or methacrylate-butadiene-styrene polymers such as acrylonitrile-butadiene-styrene (ABS) or methacrylate-butadiene-styrene (MBS). These blends have increased flame retardance and suitably maintain their mechanical and/or processing properties as well. Methods for preparing and/or using the same are also disclosed.

In one or more of the embodiments, a flame retardant polymer composition is disclosed, comprising:
a blend of a polycarbonate polymer and a butadiene-styrene based polymer; and
from about 0.5% to about 3% by weight of a filler, based on the total weight of the polymer composition;
wherein the filler is selected from the group consisting of a clay, talc, and aluminum oxide particles.

The polymer composition may have a flexural modulus of at least about 2500 MPa, according to ASTM D790; an Izod impact strength of at least about 700 J/m at 23° C., according to ASTM D256; a Charpy impact strength of at least 40 kJ/m², according to ISO 179/1eA; and/or an Izod impact strength of at least 40 kJ/m², according to ISO 180/1A. An article molded from the polymer composition may be able to attain UL94 V0 performance at a thickness of 1.5, 1.2, or 1.0 millimeters.

The polymer composition may have a melt flow rate of at least 20 g/10 minutes at 260° C., 2.16 kg load, according to ASTM D1238. The filler may be present in an amount of from about 1% to about 2% by weight, based on the total weight of the polymer composition. The weight ratio of butadiene-styrene based polymer to polycarbonate polymer may be from 1:99 to 20:80. The filler may have a median particle size of from about 0.01 microns to about 2.0 microns, or from about 0.4 microns to about 1.3 microns. The polymer composition may further comprise a salt-based flame retardant, a phosphorous-based flame retardant, bisphenol-A bis(diphenyl phosphate), or a polycarbonate-polysiloxane copolymer in addition to the blend. In some embodiments, the butadiene-styrene based polymer is selected from the group consisting of an acrylonitrile-butadiene-styrene polymer, a methacrylate-butadiene-styrene polymer, and combinations thereof.

In some embodiments, an article molded from the polymer composition can attain UL94 5VB performance at a thickness of 1.5 millimeters. Additionally, the polymer composition can have a melt flow rate of at least 20 g/10 minutes at 260° C., 2.16 kg load, according to ASTM D1238.

In other embodiments, an article molded from the polymer composition can attain UL94 V0 performance at a thickness of 1.2 millimeters and can attain UL94 5VB performance at a thickness of 2.0 millimeters. The polymer composition may also have a heat deflection temperature of at least 115° C., according to ASTM D648.

In still further embodiments, an article molded from the polymer composition can attain UL94 5VB performance at a thickness of 1.8 millimeters; and the polymer composition has a melt flow rate of at least 30 g/10 minutes at 260° C., 2.16 kg load, according to ASTM D1238.

In still other embodiments, a flame retardant polymer composition is disclosed, comprising:
a blend of a polycarbonate (PC) polymer and an impact modifier; and
from about 0.5% to about 3% by weight of a clay, based on the total weight of the polymer composition;
wherein the filler is selected from the group consisting of a clay, talc, and aluminum oxide particles; and
wherein the weight ratio of impact modifier to polycarbonate polymer is from 1:99 to 20:80.

In other embodiments, an article molded from a flame retardant polymer composition is disclosed, the polymer composition comprising:
a blend of a polycarbonate (PC) polymer and a butadiene-styrene based polymer; and
from about 0.5% to about 3% by weight of a filler, based on the total weight of the polymer composition;
wherein the filler is selected from the group consisting of a clay, talc, and aluminum oxide nanoparticles. The article can attain UL94 V0 performance at a thickness of 1.5, 1.2, and 1.0 millimeters.

In yet other embodiments, a method of making a flame retardant polymer composition is disclosed, comprising:
providing a blend of a polycarbonate (PC) polymer and a butadiene-styrene based polymer; and
adding to the blend a filler selected from the group consisting of a clay, talc, and aluminum oxide nanoparticles, to form a polymer composition,
wherein the filler is added in the amount of from about 0.5% to about 3% by weight, based on the total weight of the polymer composition.

These and other non-limiting characteristics are more particularly described below.

### DETAILED DESCRIPTION

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

The present disclosure may be understood more readily by reference to the following detailed description of preferred embodiments and the examples included therein. In the following specification and the claims which follow, reference will be made to a number of terms which shall be defined to have the following meanings.

The singular forms “a,” “an,” and “the” include plural referents unless the context clearly dictates otherwise. All ranges disclosed herein are inclusive of the recited endpoint and independently combinable (for example, the range of “from 2 grams to 10 grams” is inclusive of the endpoints, 2 grams and 10 grams, and all the intermediate values).

The modifier “about” used in connection with a quantity is inclusive of the stated value and has the meaning dictated by the context (for example, it includes at least the degree of error associated with the measurement of the particular quantity).

Compounds and/or compositions are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The polymer compositions of the present disclosure comprise (i) a blend of (a) a polycarbonate polymer and (b) an impact modifier, such as a butadiene-styrene based polymer; and (ii) from about 0.5% to about 3% by weight of a filler, based on the total weight of the polymer composition, wherein the filler is selected from the group consisting of a clay, talc, and aluminum oxide particles, including nanoparticles.

Polycarbonate polymers suitable for the blend generally contain a repeating structural carbonate unit of the formula (1):

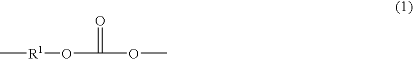

in which at least 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):

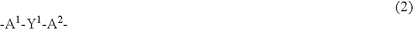

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)

HO-A¹-Y¹-A²-OH (3)

wherein Y¹, A¹ and A² are as described above. Also included are bisphenol compounds of general formula (4):

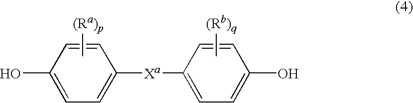

wherein R^{a} and R^{b} each represent a halogen atom or a monovalent hydrocarbon group and may be the same or different; p and q are each independently integers of 0 to 4; and X^{a} represents one of the groups of formula (5):

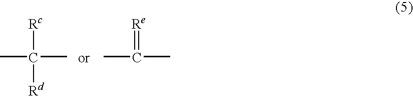

wherein R^{C} and R^{d} each independently represent a hydrogen atom or a monovalent linear or cyclic hydrocarbon group and R^{e} is a divalent hydrocarbon group.

In an embodiment, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)-, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group may have 3 to 20 atoms, and may be a single saturated or unsaturated ring, or fused polycyclic ring system wherein the fused rings are saturated, unsaturated, or aromatic.

Other bisphenols containing substituted or unsubstituted cyclohexane units can be used, for example bisphenols of formula (6):

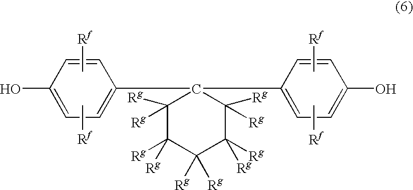

wherein each R^{f} is independently hydrogen, C₁₋₁₂ alkyl, or halogen; and each R^{g} is independently hydrogen or C₁₋₁₂ alkyl. The substituents may be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures.

Polycarbonate copolymers are also contemplated for use in the instant processes. A specific type of copolymer is a polyester carbonate, also known as a polyester-polycarbonate. Such copolymers further contain, in addition to recurring carbonate chain units of the formula (1), repeating units of formula (8):

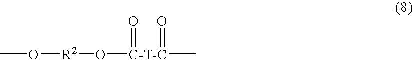

wherein R² is a divalent group derived from a dihydroxy compound, and may be, for example, a C₂₋₁₀ alkylene group, a C₆₋₂₀ alicyclic group, a C₆₋₂ aromatic group or a polyoxyalkylene group in which the alkylene groups contain 2 to about 6 carbon atoms, specifically 2, 3, or 4 carbon atoms; and T divalent group derived from a dicarboxylic acid, and may be, for example, a C₂₋₁₀ alkylene group, a C₆₋₂₀ alicyclic group, a C₆₋₂₀ alkyl aromatic group, or a C₆₋₂₀ aromatic group.

In an embodiment, R² is a C₂₋₃₀ alkylene group having a straight chain, branched chain, or cyclic (including polycyclic) structure. In another embodiment, R² is derived from an aromatic dihydroxy compound of formula (4) above. In another embodiment, R² is derived from an aromatic dihydroxy compound of formula (7) above.

Examples of aromatic dicarboxylic acids that may be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations thereof. A specific dicarboxylic acid comprises a combination of isophthalic acid and terephthalic acid wherein the weight ratio of isophthalic acid to terephthalic acid is about 91:9 to about 2:98. In another specific embodiment, R² is a C₂₋₆ alkylene group and T is p-phenylene, m-phenylene, naphthalene, a divalent cycloaliphatic group, or a combination thereof. This class of polyester includes the poly(alkylene terephthalates).

The polyesters may be obtained by interfacial polymerization or melt-process condensation as described above, by solution phase condensation, or by transesterification polymerization wherein, for example, a dialkyl ester such as dimethyl terephthalate may be transesterified with ethylene glycol using acid catalysis, to generate poly(ethylene terephthalate). It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

Useful polyesters may include aromatic polyesters, poly(alkylene esters) including poly(alkylene arylates), and poly(cycloalkylene diesters). Aromatic polyesters may have a polyester structure according to formula (8), wherein D and T are each aromatic groups as described hereinabove. In an embodiment, useful aromatic polyesters may include, for example, poly(isophthalate-terephthalate-resorcinol) esters, poly(isophthalate-terephthalate-bisphenol-A) esters, poly[(isophthalate-terephthalate-resorcinol) ester-co-(isophthalate-terephthalate-bisphenol-A)]ester, or a combination comprising at least one of these. Also contemplated are aromatic polyesters with a minor amount, e.g., about 0.5% by weight to about 10% by weight, based on the total weight of the polyester, of units derived from an aliphatic diacid and/or an aliphatic polyol to make copolyesters. Poly(alkylene arylates) may have a polyester structure according to formula (8), wherein T comprises groups derived from aromatic dicarboxylates, cycloaliphatic dicarboxylic acids, or derivatives thereof. Examples of specifically useful T groups include 1,2-, 1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups D include, for example, ethylene, 1,4-butylene, and bis-(alkylene-disubstituted cyclohexane) including cis- and/or trans-1,4-(cyclohexylene)dimethylene. Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations comprising at least one of the foregoing polyesters may also be used.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexane-dimethanol-1,4-cyclohexanedicarboxylate) (PCCD), having recurring units of formula (9):

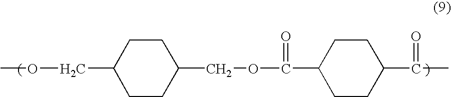

wherein, as described using formula (8), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

Another type of polycarbonate copolymer is a polysiloxane-polycarbonate copolymer. The polysiloxane (also referred to herein as “polydiorganosiloxane”) blocks of the copolymer comprise repeating siloxane units (also referred to herein as “diorganosiloxane units”) of formula (10):

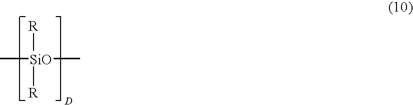

wherein each occurrence of R is same or different, and is a C₁₋₁₃ monovalent organic radical. For example, R may independently be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ arylalkyl group, C₇-C₁₃ arylalkoxy group, C₇-C₁₃ alkylaryl group, or C₇-C₁₃ alkylaryloxy group. The foregoing groups may be fully or partially halogenated with fluorine, chlorine, bromine, or iodine, or a combination thereof. Combinations of the foregoing R groups may be used in the same copolymer.

The value of D in formula (10) may vary widely depending on the type and relative amount of each component in the polymer, the desired properties of the polymer, and like considerations. Generally, D may have an average value of 2 to 1,000, specifically 2 to 500, and more specifically 5 to 100. In one embodiment, D has an average value of 10 to 75, and in still another embodiment, D has an average value of 30 to 45. The phrase “average value” is used to indicate that various siloxane blocks of siloxane units in the PC-Si copolymer may have different lengths.

In some embodiments, the siloxane unit may be derived from structural units of formula (11):

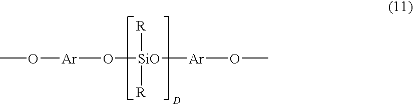

wherein D is as defined above; each R may independently be the same or different, and is as defined above; and each Ar may independently be the same or different, and is a substituted or unsubstituted C₆-C₃₀ arylene radical, wherein the bonds are directly connected to an aromatic moiety. Useful Ar groups in formula (11) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of dihydroxyarylene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulphide), and 1,1-bis(4-hydroxy-t-butylphenyl)propane. Combinations comprising at least one of the foregoing dihydroxy compounds may also be used.

Units of formula (11) may be derived from the corresponding dihydroxy compound of formula (12):

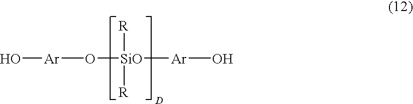

wherein R, Ar, and D are as described above. Compounds of formula (12) may be obtained by the reaction of a dihydroxyarylene compound with, for example, an alpha, omega-bisacetoxypolydiorganosiloxane under phase transfer conditions.

In other embodiments, the siloxane unit may be derived from structural units of formula (13):

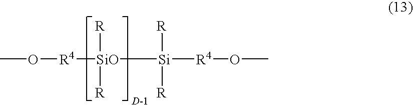

wherein R and D are as described above, and each occurrence of R⁴ is independently a divalent C₁-C₃₀ alkylene, and wherein the polymerized polysiloxane unit is the reaction residue of its corresponding dihydroxy compound.

In other embodiments, the siloxane unit may be derived from structural units of formula (14):

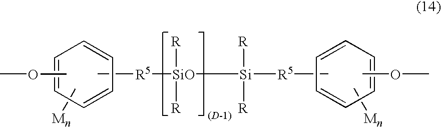

wherein R and D are as defined above. Each R⁵ in formula (14) is independently a divalent C₂-C₈ aliphatic group. Each M in formula (14) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R⁵ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R⁵ is a divalent C₁-C₃ aliphatic group, and R is methyl.

Units of formula (14) may be derived from the corresponding dihydroxy polydiorganosiloxane (15):

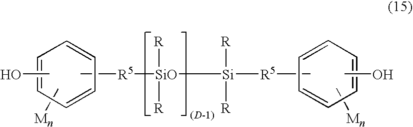

wherein R, D, M, R⁵, and n are as described above. Such dihydroxy polysiloxanes can be made by effecting a platinum catalyzed addition between a siloxane hydride of formula (16):

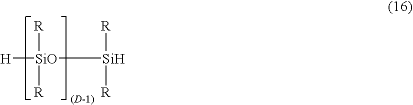

wherein R and D are as previously defined, and an aliphatically unsaturated monohydric phenol. Useful aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

Polycarbonates and copolymers may be made by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol-A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used. In an exemplary embodiment, an interfacial polymerization reaction to form carbonate linkages uses phosgene as a carbonate precursor, and is referred to as a phosgenation reaction.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst may be about 0.1% by weight to about 10% by weight based on the weight of bisphenol in the phosgenation mixture. In another embodiment an effective amount of phase transfer catalyst may be about 0.5% by weight to about 2% by weight based on the weight of bisphenol in the phosgenation mixture.

Branched polycarbonate blocks may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05% by weight to about 2.0% by weight. Mixtures comprising linear polycarbonates and branched polycarbonates may be used.

The polycarbonate polymer used in the blend may be a polycarbonate homopolymer, a polyester-polycarbonate copolymer, or a polysiloxane-polycarbonate copolymer. In more specific embodiments, the polycarbonate polymer used in the blend is a polycarbonate homopolymer.

In specific embodiments, the polycarbonate polymer is derived from a dihydroxy compound having the structure of Formula (I):

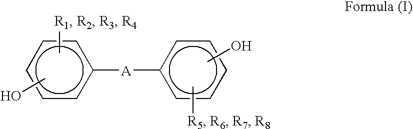

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (I) is 2,2-bis(4-hydroxyphenyl)propane (i.e. bisphenol-A or BPA). Other illustrative compounds of Formula (I) include:
2,2-bis(3-bromo-4-hydroxyphenyl)propane;
2,2-bis(4-hydroxy-3-methylphenyl)propane;
2,2-bis(4-hydroxy-3-isopropylphenyl)propane;
2,2-bis(3-t-butyl-4-hydroxyphenyl)propane;
2,2-bis(3-phenyl-4-hydroxyphenyl)propane;
2,2-bis(3,5-dichloro-4-hydroxyphenyl)propane;
1,1-bis(4-hydroxyphenyl)cyclohexane;
1,1-bis(3-chloro-4-hydroxyphenyl)-3,3,5-trimethylcyclohexane;
4,4′dihydroxy-1,1-biphenyl;
4,4′-dihydroxy-3,3′-dimethyl-1,1-biphenyl;
4,4′-dihydroxy-3,3′-dioctyl-1,1-biphenyl;
4,4′-dihydroxydiphenylether;
4,4′-dihydroxydiphenylthioether; and
1,3-bis(2-(4-hydroxyphenyl)-2-propyl)benzene.

The blend further comprises an impact modifier. Exemplary impact modifiers include acrylics, chlorinated polyethylene (CPE), ethylene vinyl acetate (EVA) copolymers, and butadiene-styrene based polymers like ABS or MBS. An exemplary impact modifier is bulk polymerized ABS. The bulk polymerized ABS comprises an elastomeric phase comprising (i) butadiene and having a Tg of less than about 10° C., and (ii) a rigid polymeric phase having a Tg of greater than about 15° C. and comprising a copolymer of a monovinylaromatic monomer such as styrene and an unsaturated nitrile such as acrylonitrile. Such ABS polymers may be prepared by first providing the elastomeric polymer, then polymerizing the constituent monomers of the rigid phase in the presence of the elastomer to obtain the graft copolymer. The grafts may be attached as graft branches or as shells to an elastomer core. The shell may merely physically encapsulate the core, or the shell may be partially or essentially completely grafted to the core.

Polybutadiene homopolymer may be used as the elastomer phase. Alternatively, the elastomer phase of the bulk polymerized ABS comprises butadiene copolymerized with up to about 25 weight percent of another conjugated diene monomer of formula (17):

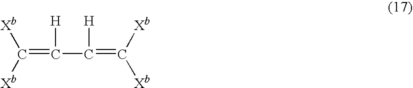

wherein each X^{b} is independently C₁-C₅ alkyl. Examples of conjugated diene monomers that may be used are isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. A specific conjugated diene is isoprene.

The elastomeric butadiene phase may additionally be copolymerized with up to 25 weight percent, specifically up to about 15 weight percent, of another comonomer, for example monovinylaromatic monomers containing condensed aromatic ring structures such as vinyl naphthalene, vinyl anthracene and the like, or monomers of formula (18):

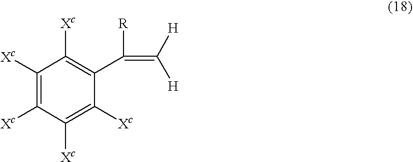

wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Examples of suitable monovinylaromatic monomers copolymerizable with the butadiene include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing monovinylaromatic monomers. In one embodiment, the butadiene is copolymerized with up to about 12 weight percent, specifically about 1 to about 10 weight percent styrene and/or alpha-methyl styrene.

Other monomers that may be copolymerized with the butadiene are monovinylic monomers such as itaconic acid, acrylamide, N-substituted acrylamide or methacrylamide, maleic anhydride, maleimide, N-alkyl-, aryl-, or haloaryl-substituted maleimide, glycidyl(meth)acrylates, and monomers of the generic formula (19):

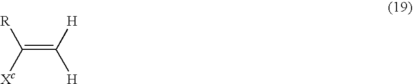

wherein R is hydrogen, C₁-C₅ alkyl, bromo, or chloro, and X^{c} is cyano, C₁-C₁₂ alkoxycarbonyl, C₁-C₁₂ aryloxycarbonyl, hydroxy carbonyl, and the like. Examples of monomers of formula (19) include acrylonitrile, ethacrylonitrile, methacrylonitrile, alpha-chloroacrylonitrile, beta-chloroacrylonitrile, alpha-bromoacrylonitrile, acrylic acid, methyl (meth)acrylate, ethyl(meth)acrylate, n-butyl(meth)acrylate, t-butyl(meth)acrylate, n-propyl (meth)acrylate, isopropyl(meth)acrylate, 2-ethylhexyl(meth)acrylate, and the like, and combinations comprising at least one of the foregoing monomers. Monomers such as n-butyl acrylate, ethyl acrylate, and 2-ethylhexyl acrylate are commonly used as monomers copolymerizable with the butadiene.

The particle size of the butadiene phase is not critical, and may be, for example about 0.01 to about 20 micrometers, specifically about 0.5 to about 10 micrometers, more specifically about 0.6 to about 1.5 micrometers may be used for bulk polymerized rubber substrates. Particle size may be measured by light transmission methods or capillary hydrodynamic chromatography (CHDF). The butadiene phase may provide about 5 to about 95 weight percent of the total weight of the ABS impact modifier copolymer, more specifically about 20 to about 90 weight percent, and even more specifically about 40 to about 85 weight percent of the ABS impact modifier, the remainder being the rigid graft phase.

The rigid graft phase comprises a copolymer formed from a styrenic monomer composition together with an unsaturated monomer comprising a nitrile group. As used herein, “styrenic monomer” includes monomers of formula (18) wherein each X^{c} is independently hydrogen, C₁-C₄ alkyl, phenyl, C₇-C₉ aralkyl, C₇-C₉ alkaryl, C₁-C₄ alkoxy, phenoxy, chloro, bromo, or hydroxy, and R is hydrogen, C₁-C₂ alkyl, bromo, or chloro. Specific examples styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like. Combinations comprising at least one of the foregoing styrenic monomers may be used.

Further as used herein, an unsaturated monomer comprising a nitrile group includes monomers of formula (19) wherein R is hydrogen, C₁-C₅ alkyl, bromo, or chloro, and X^{c} is cyano. Specific examples include acrylonitrile, ethacrylonitrile, methacrylonitrile, alpha-chloroacrylonitrile, beta-chloroacrylonitrile, alpha-bromoacrylonitrile, and the like. Combinations comprising at least one of the foregoing monomers may be used.

The rigid graft phase of the bulk polymerized ABS may further optionally comprise other monomers copolymerizable therewith, including other monovinylaromatic monomers and/or monovinylic monomers such as itaconic acid, acrylamide, N-substituted acrylamide or methacrylamide, maleic anhydride, maleimide, N-alkyl-, aryl-, or haloaryl-substituted maleimide, glycidyl(meth)acrylates, and monomers of the generic formula (19). Specific comonomers include C₁-C₄ alkyl (meth)acrylates, for example methyl methacrylate.

The rigid copolymer phase will generally comprise about 10 to about 99 weight percent, specifically about 40 to about 95 weight percent, more specifically about 50 to about 90 weight percent of the styrenic monomer; about 1 to about 90 weight percent, specifically about 10 to about 80 weight percent, more specifically about 10 to about 50 weight percent of the unsaturated monomer comprising a nitrile group; and 0 to about 25 weight percent, specifically 1 to about 15 weight percent of other comonomer, each based on the total weight of the rigid copolymer phase.

The bulk polymerized ABS copolymer may further comprise a separate matrix or continuous phase of ungrafted rigid copolymer that may be simultaneously obtained with the ABS. The ABS may comprise about 40 to about 95 weight percent elastomer-modified graft copolymer and about 5 to about 65 weight percent rigid copolymer, based on the total weight of the ABS. In another embodiment, the ABS may comprise about 50 to about 85 weight percent, more specifically about 75 to about 85 weight percent elastomer-modified graft copolymer, together with about 15 to about 50 weight percent, more specifically about 15 to about 25 weight percent rigid copolymer, based on the total weight of the ABS.

A variety of bulk polymerization methods for ABS-type resins are known. In multizone plug flow bulk processes, a series of polymerization vessels (or towers), consecutively connected to each other, providing multiple reaction zones. The elastomeric butadiene may be dissolved in one or more of the monomers used to form the rigid phase, and the elastomer solution is fed into the reaction system. During the reaction, which may be thermally or chemically initiated, the elastomer is grafted with the rigid copolymer (i.e., SAN). Bulk copolymer (referred to also as free copolymer, matrix copolymer, or non-grafted copolymer) is also formed within the continuous phase containing the dissolved rubber. As polymerization continues, domains of free copolymer are formed within the continuous phase of rubber/comonomers to provide a two-phase system. As polymerization proceeds, and more free copolymer is formed, the elastomer-modified copolymer starts to disperse itself as particles in the free copolymer and the free copolymer becomes a continuous phase (phase inversion). Some free copolymer is generally occluded within the elastomer-modified copolymer phase as well. Following the phase inversion, additional heating may be used to complete polymerization. Numerous modifications of this basic process have been described, for example in U.S. Pat. No. 3,511,895, which describes a continuous bulk ABS process that provides controllable molecular weight distribution and microgel particle size using a three-stage reactor system. In the first reactor, the elastomer/monomer solution is charged into the reaction mixture under high agitation to precipitate discrete rubber particle uniformly throughout the reactor mass before appreciable cross-linking can occur. Solids levels of the first, the second, and the third reactor are carefully controlled so that molecular weights fall into a desirable range. U.S. Pat. No. 3,981,944 discloses extraction of the elastomer particles using the styrenic monomer to dissolve/disperse the elastomer particles, prior to addition of the unsaturated monomer comprising a nitrile group and any other comonomers. U.S. Pat. No. 5,414,045 discloses reacting in a plug flow grafting reactor a liquid feed composition comprising a styrenic monomer composition, an unsaturated nitrile monomer composition, and an elastomeric butadiene polymer to a point prior to phase inversion, and reacting the first polymerization product (grafted elastomer) therefrom in a continuous-stirred tank reactor to yield a phase inverted second polymerization product that then can be further reacted in a finishing reactor, and then devolatilized to produce the desired final product.

Additional impact modifiers include elastomer-modified graft copolymers comprising (i) an elastomeric (i.e., rubbery) polymer substrate having a Tg less than about 10° C., more specifically less than about minus 10° C., or more specifically about minus 40° to minus 80° C., and (ii) a rigid polymeric superstrate grafted to the elastomeric polymer substrate. The grafts may be attached as graft branches or as shells to an elastomer core. The shell may merely physically encapsulate the core, or the shell may be partially or essentially completely grafted to the core.

Suitable materials for use as the elastomer phase include, for example, conjugated diene rubbers; copolymers of a conjugated diene with less than about 50 weight percent of a copolymerizable monomer; olefin rubbers such as ethylene propylene copolymers (EPR) or ethylene-propylene-diene monomer rubbers (EPDM); ethylene-vinyl acetate rubbers; elastomeric C₁₋₈ alkyl(meth)acrylates; elastomeric copolymers of C₁₋₈ alkyl(meth)acrylates with butadiene and/or styrene; or combinations comprising at least one of the foregoing elastomers. In one embodiment, the elastomer phase of the impact modifier is diene or butadiene based.

Suitable conjugated diene monomers for preparing the elastomer phase are of formula (17) above wherein each X^{b} is independently hydrogen, C₁-C₅ alkyl, and the like. Examples of conjugated diene monomers that may be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. Specific conjugated diene homopolymers include polybutadiene and polyisoprene.

Copolymers of a conjugated diene rubber may also be used, for example those produced by aqueous radical emulsion polymerization of a conjugated diene and one or more monomers copolymerizable therewith. Monomers that are suitable for copolymerization with the conjugated diene include monovinylaromatic monomers containing condensed aromatic ring structures, such as vinyl naphthalene, vinyl anthracene and the like, or monomers of formula (18) above, wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Examples of suitable monovinylaromatic monomers that may be used include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, combinations comprising at least one of the foregoing compounds, and the like. Styrene and/or alpha-methylstyrene are commonly used as monomers copolymerizable with the conjugated diene monomer.

Other monomers that may be copolymerized with the conjugated diene are monovinylic monomers such as itaconic acid, acrylamide, N-substituted acrylamide or methacrylamide, maleic anhydride, maleimide, N-alkyl-, aryl-, or haloaryl-substituted maleimide, glycidyl(meth)acrylates, and monomers of the generic formula (19) wherein R is hydrogen, C₁-C₅ alkyl, bromo, or chloro, and X^{c} is cyano, C₁-C₁₂ alkoxycarbonyl, C₁-C₁₂ aryloxycarbonyl, hydroxy carbonyl, and the like. Examples of monomers of formula (19) include acrylonitrile, ethacrylonitrile, methacrylonitrile, alpha-chloroacrylonitrile, beta-chloroacrylonitrile, alpha-bromoacrylonitrile, acrylic acid, methyl (meth)acrylate, ethyl(meth)acrylate, n-butyl(meth)acrylate, t-butyl(meth)acrylate, n-propyl (meth)acrylate, isopropyl(meth)acrylate, 2-ethylhexyl(meth)acrylate, and the like, and combinations comprising at least one of the foregoing monomers. Monomers such as n-butyl acrylate, ethyl acrylate, and 2-ethylhexyl acrylate are commonly used as monomers copolymerizable with the conjugated diene monomer. Mixtures of the foregoing monovinyl monomers and monovinylaromatic monomers may also be used.

Certain (meth)acrylate monomers may also be used to provide the elastomer phase, including cross-linked, particulate emulsion homopolymers or copolymers of C₁₋₁₆ alkyl(meth)acrylates, specifically C₁₋₉ alkyl(meth)acrylates, in particular C₄₋₆ alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. The C₁₋₁₆ alkyl(meth)acrylate monomers may optionally be polymerized in admixture with up to 15 weight percent of comonomers of generic formulas (17), (18), or (19) as broadly described above. Exemplary comonomers include but are not limited to butadiene, isoprene, styrene, methyl methacrylate, phenyl methacrylate, phenethylmethacrylate, N-cyclohexylacrylamide, vinyl methyl ether or acrylonitrile, and mixtures comprising at least one of the foregoing comonomers. Optionally, up to 5 weight percent a polyfunctional crosslinking comonomer may be present, for example divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl(meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

The elastomer phase may be polymerized by mass, emulsion, suspension, solution or combined processes such as bulk-suspension, emulsion-bulk, bulk-solution or other techniques, using continuous, semibatch, or batch processes. The particle size of the elastomer substrate is not critical. For example, an average particle size of about 0.001 to about 25 micrometers, specifically about 0.01 to about 15 micrometers, or even more specifically about 0.1 to about 8 micrometers may be used for emulsion based polymerized rubber lattices. A particle size of about 0.5 to about 10 micrometers, specifically about 0.6 to about 1.5 micrometers may be used for bulk polymerized rubber substrates. The elastomer phase may be a particulate, moderately cross-linked copolymer derived from conjugated butadiene or C₄₋₉ alkyl acrylate rubber, and preferably has a gel content greater than 70%. Also suitable are copolymers derived from mixtures of butadiene with styrene, acrylonitrile, and/or C₄₋₆ alkyl acrylate rubbers.

The elastomeric phase may provide about 5 to about 95 weight percent of the elastomer-modified graft copolymer, more specifically about 20 to about 90 weight percent, and even more specifically about 40 to about 85 weight percent, the remainder being the rigid graft phase.

The rigid phase of the elastomer-modified graft copolymer may be formed by graft polymerization of a mixture comprising a monovinylaromatic monomer and optionally one or more comonomers in the presence of one or more elastomeric polymer substrates. The above broadly described monovinylaromatic monomers of formula (18) may be used in the rigid graft phase, including styrene, alpha-methyl styrene, halostyrenes such as dibromostyrene, vinyltoluene, vinylxylene, butylstyrene, para-hydroxystyrene, methoxystyrene, and others, or combinations comprising at least one of the foregoing monovinylaromatic monomers. Suitable comonomers include, for example, the above broadly described monovinylic monomers and/or monomers of the general formula (19). In one embodiment, R is hydrogen or C₁-C₂ alkyl, and X^{c} is cyano or C₁-C₁₂ alkoxycarbonyl. Specific examples of suitable comonomers for use in the rigid phase include acrylonitrile, ethacrylonitrile, methacrylonitrile, methyl(meth)acrylate, ethyl(meth)acrylate, n-propyl(meth)acrylate, isopropyl(meth)acrylate, and the like, and combinations comprising at least one of the foregoing comonomers.

In one specific embodiment, the rigid graft phase is formed from styrene or alpha-methyl styrene copolymerized with ethyl acrylate and/or methyl methacrylate. In other specific embodiments, the rigid graft phase is formed from styrene copolymerized with methyl methacrylate; and styrene copolymerized with methyl methacrylate and acrylonitrile.

The relative ratio of monovinylaromatic monomer and comonomer in the rigid graft phase may vary widely depending on the type of elastomer substrate, type of monovinylaromatic monomer(s), type of comonomer(s), and the desired properties of the impact modifier. The rigid phase may generally comprise up to 100 weight percent of monovinyl aromatic monomer, specifically about 30 to about 100 weight percent, more specifically about 50 to about 90 weight percent monovinylaromatic monomer, with the balance being comonomer(s).

Depending on the amount of elastomer-modified polymer present, a separate matrix or continuous phase of ungrafted rigid polymer or copolymer may be simultaneously obtained along with the additional elastomer-modified graft copolymer. Typically, such impact modifiers comprise about 40 to about 95 weight percent elastomer-modified graft copolymer and about 5 to about 65 weight percent rigid (co)polymer, based on the total weight of the impact modifier. In another embodiment, such impact modifiers comprise about 50 to about 85 weight percent, more specifically about 75 to about 85 weight percent rubber-modified rigid copolymer, together with about 15 to about 50 weight percent, more specifically about 15 to about 25 weight percent rigid (co)polymer, based on the total weight of the impact modifier.

Specific examples of elastomer-modified graft copolymers include but are not limited to, methyl methacrylate-acrylonitrile-butadiene-styrene (MABS), methyl methacrylate-butadiene-styrene (MBS), and acrylonitrile-ethylene-propylene-diene-styrene (AES).

If desired, the optional additional impact modifier may be prepared by an emulsion polymerization process that is free of basic species, for example species such as alkali metal salts of C₆₋₃₀ fatty acids, for example sodium stearate, lithium stearate, sodium oleate, potassium oleate, and others, alkali metal carbonates, amines such as dodecyl dimethyl amine, dodecyl amine, and others, and ammonium salts of amines, if desired, but it is not a requirement. Such materials are commonly used as polymerization aids, that is, surfactants in emulsion polymerization, and may catalyze transesterification and/or degradation of polycarbonates. Instead, ionic sulfate, sulfonate or phosphate surfactants may be used in preparing the impact modifiers, particularly the elastomeric substrate portion of the impact modifiers, if desired. Suitable surfactants include, for example, C₁₋₂₂ alkyl or C₇₋₂₅ alkylaryl sulfonates, C₁₋₂₂ alkyl or C₇₋₂₅ alkylaryl sulfates, C₁₋₂₂ alkyl or C₇₋₂₅ alkylaryl phosphates, substituted silicates, and combinations comprising at least one of the foregoing surfactants. A specific surfactant is a C₆₋₁₆, specifically a C₈₋₁₂ alkyl sulfonate. This emulsion polymerization process is described and disclosed in various patents and literature of such companies as Rohm & Haas and General Electric Company.

Another specific type of elastomer-modified impact modifier comprises structural units derived from at least one silicone rubber monomer, a branched acrylate rubber monomer having the formula H₂C═C(R^{d})C(O)OCH₂CH₂R^{e}, wherein R^{d} is hydrogen or a C₁-C₉ linear or branched hydrocarbyl group and R^{e} is a branched C₃-C₁₆ hydrocarbyl group; a first graft link monomer; a polymerizable alkenyl-containing organic material; and a second graft link monomer. The silicone rubber monomer may comprise, for example, a cyclic siloxane, tetraalkoxysilane, trialkoxysilane, (acryloxy)alkoxysilane, (mercaptoalkyl)alkoxysilane, vinylalkoxysilane, or allylalkoxysilane, alone or in combination, for example, decamethylcyclopentasiloxane, dodecamethylcyclohexasiloxane, trimethyltriphenylcyclotrisiloxane, tetramethyltetraphenylcyclotetrasiloxane, tetramethyltetravinylcyclotetrasiloxane, octaphenylcyclotetrasiloxane, octamethylcyclotetrasiloxane and/or tetraethoxysilane.

Exemplary branched acrylate rubber monomers include iso-octyl acrylate, 6-methyloctyl acrylate, 7-methyloctyl acrylate, 6-methylheptyl acrylate, and others known in the art, alone or in combination. The polymerizable alkenyl-containing organic material may be, for example, a monomer of formula (18) or (19), for example, styrene, alpha-methylstyrene, acrylonitrile, methacrylonitrile, or an unbranched (meth)acrylate such as methyl methacrylate, 2-ethylhexyl methacrylate, methyl acrylate, ethyl acrylate, n-propyl acrylate, and others known in the art, alone or in combination.

The at least one first graft link monomer may be an (acryloxy)alkoxysilane, a (mercaptoalkyl)alkoxysilane, a vinylalkoxysilane, or an allylalkoxysilane, alone or in combination, for example, (gamma-methacryloxypropyl)(dimethoxy)methylsilane and/or (3-mercaptopropyl)trimethoxysilane. The at least one second graft link monomer is a polyethylenically unsaturated compound having at least one allyl group, such as allyl methacrylate, triallyl cyanurate, or triallyl isocyanurate, alone or in combination.

The silicone-acrylate impact modifier compositions can be prepared by emulsion polymerization, wherein, for example at least one silicone rubber monomer is reacted with at least one first graft link monomer at a temperature from about 30° C. to about 110° C. to form a silicone rubber latex, in the presence of a surfactant such as dodecylbenzenesulfonic acid. Alternatively, a cyclic siloxane such as cyclooctamethyltetrasiloxane and an tetraethoxyorthosilicate may be reacted with a first graft link monomer such as (gamma-methacryloxypropyl)methyldimethoxysilane, to afford silicone rubber having an average particle size from about 100 nanometers to about 2 microns. At least one branched acrylate rubber monomer is then polymerized with the silicone rubber particles, optionally in presence of a cross linking monomer, such as allylmethacrylate in the presence of a free radical generating polymerization catalyst such as benzoyl peroxide. This latex is then reacted with a polymerizable alkenyl-containing organic material and a second graft link monomer. The latex particles of the graft silicone-acrylate rubber hybrid may be separated from the aqueous phase through coagulation (by treatment with a coagulant) and dried to a fine powder to produce the silicone-acrylate rubber impact modifier composition. This method can be generally used for producing the silicone-acrylate impact modifier having a particle size from about 100 nanometers to about two micrometers.

In specific embodiments, the impact modifier is a butadiene-styrene based polymer such as an acrylonitrile-butadiene-styrene (ABS) polymer, a methacrylate-butadiene-styrene (MBS) polymer, or combinations thereof. ABS polymers are made by polymerizing styrene and acrylonitrile in the presence of polybutadiene. MBS polymers are made by polymerizing styrene and methacrylate in the presence of polybutadiene. For reference, the four separate monomers are shown below:

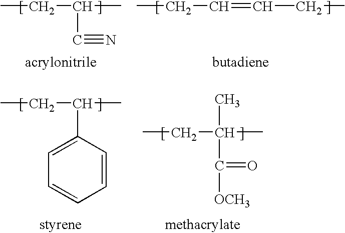

In embodiments, the weight ratio of butadiene-styrene based polymer to polycarbonate polymer is from 1:99 to 20:80.

The polymer composition further comprises from about 0.5% to about 3% by weight of a filler selected from the group consisting of a clay, talc, and aluminum oxide particles, based on the total weight of the polymer composition. In more specific embodiments, the filler is present in the amount of from about 1% to about 2% by weight.

Clays are generally hydrated silicates comprising aluminum, magnesium, iron, and/or other metals. They are components of various soils and varying in percentages. They are insoluble in water and organic solvents. They absorb water to form a moldable mass and in some cases a thixotropic gel. They are important in soil chemistry and construction engineering. Among other uses, they can be used for ceramic products, refractories, colloidal suspensions, oil-well drilling fluids, fillers for rubber and plastic products, films, coatings, filtration, carriers, and as catalysts.

The clay may be natural or synthetic. The clay may be a phyllosilicate. Exemplary clays include, but are not limited to, saponite, hectorite, mica, vermiculite, bentonite, nontronite, beidellite, volkonskoite, saponite, magadite, and kenyaite. Suitable clays are available from various commercial sources such as Nanocor, Inc., Laviosa Chimica Mineraria, Southern Clay Products, Kunimine Industries, Ltd., and Elementis Specialties, Inc.

Other exemplary clays include: apophyllite, bannisterite, carletonite, cavansite, chrysocolla, delhayelite, elpidite, fedorite, linfurnaceite, gonyerite, gyrolite, leucosphenite, minehillite, nordite, pentagonite, petalite, prehnite, rhodesite, sanbornite; chlorite clays such as baileychlore, chamosite, general categories of chlorite mineral, cookeite, nimite, pennantite, penninite and sudoite; glauconite, illite, kaolinite, palygorskite, pyrophyllite, sauconite, talc, lepidolite, muscovite, paragonite, phlogopite, zinnwaldite; antigorite [(Mg,Fe)₃Si₂O₅(OH)₄, having a monoclinic structure]; clinochrysotile [Mg₃Si₂O₅(OH)₄, having a monoclinic structure]; lizardite [Mg₃Si₂O₅(OH)₄, having either a trigonal or a hexagonal structure]; orthochrysotile [Mg₃Si₂O₅(OH)₄, having an orthorhombic structure]; and parachrysotile [(Mg,Fe)₃Si₂O₅(OH)₄, having an orthorhombic structure].

In specific embodiments, the clay is a kaolin clay. Kaolin is a white burning aluminum silicate that has a high fusion point and is very refractory. It comprises mainly kaolinite [Al₂O₃.2SiO₂.2H₂O] plus impurities and water.

Untreated clays generally have layered sheet-like structures, due in part to the presence of rings of tetrahedrons linked by oxygen atoms and shared with other rings in a two dimensional plane. Layers of cations, such as sodium ions, connect the sheet-like structures. These layers of cations that connect the sheet-like structures are hereinafter referred to as interlayers. The cations are weakly bonded and are surrounded by neutral molecules, such as water molecules. The distance between the layers of sheet-like structures is referred to as the “d-spacing.” The silicon to oxygen ratio in the untreated clay is generally from about 1:1 to about 2.5:1. Layered clays appear to improve the barrier and flame retardance properties of the overall polymer composition. This layered structure generally corresponds to particle size as well; particles with a median size of from about 1.0 to about 1.3 microns have a layered structure.

Fine talc is also suitable as the filler. Talc is a natural hydrous magnesium silicate [Mg₃Si₄O₁₀(OH)₂ or 3MgO.4SiO₂H₂O]. It has a number of uses including in ceramics, cosmetics, pharmaceuticals, and as filler in rubbers, paints, soaps, plaster, etc.

Additionally, aluminum oxide particles, particularly aluminum oxide nanoparticles, can be used as fillers. In particular, testing has found that use of other metal oxide nanoparticles do not provide improved flame retardance properties. For example, BaSO₄, SiO₂, TiO₂, and CaCO₃ nanoparticles do not improve the flame retardance of the polymer composition. The aluminum oxide nanoparticles may have a median particle size of from about 40 nanometers to about 50 nanometers.

In embodiments, the desired filler may have a median particle size of from about 0.01 microns to about 2.0 microns. In more specific embodiments, the filler has a median particle size of from about 0.4 microns to about 1.3 microns. Particle sizes near the low end of this range appear to maintain the ductility of the polymer composition, whereas particle sizes near the high end of this range appear to improve the barrier and flame retardance properties of the polymer composition better than those sizes at the low end of the range.

The polymer compositions of the present disclosure achieve improved flame retardance properties with very small amounts of filler while maintaining mechanical properties. For example, an article molded from the polymer composition may attain UL94 V0 performance at a thickness of 1.5 millimeters, 1.2 mm, or even 1.0 mm. An article molded from the polymer composition may attain UL94 5VB performance at a thickness of 2.0 millimeters, 1.8 mm, or even 1.5 mm. The polymer composition may also have a melt flow rate of at least 20 g/10 minutes at 260° C., 2.16 kg load, according to ASTM D1238; a flexural modulus of at least about 2500 MPa, according to ASTM D790; an Izod impact strength of at least about 700 J/m at 23° C., according to ASTM D256; a Charpy impact strength of at least 40 kJ/m², according to ISO 179/1eA; an Izod impact strength of at least 40 kJ/m², according to ISO 180/1A; or a heat deflection temperature of at least 80° C., according to ASTM D648. Of course, the polymer composition may also have any combination of these properties.

In more specific embodiments, the polymer composition may have a heat deflection temperature of at least 120° C., according to ASTM D648; or a melt flow rate of at least 15 g/10 minutes at 260° C., 5 kg load, according to ASTM D1238.

In particular embodiments, an article molded from the polymer composition can attain UL94 5VB performance at a thickness of 2.0 millimeters, 1.8 mm, or 1.5 mm; and the polymer composition has a melt flow rate of at least 20 g/10 minutes at 260° C., 2.16 kg load, according to ASTM D1238.

In other particular embodiments, an article molded from the polymer composition can attain UL94 V0 performance at a thickness of 1.2 millimeters and can attain UL94 5VB performance at a thickness of 2.0 millimeters; and the polymer composition has a heat deflection temperature of at least 115° C., according to ASTM D648.

In other particular embodiments, an article molded from the polymer composition can attain UL94 5VB performance at a thickness of 2.0 millimeters or 1.8 mm; and the polymer composition has a melt flow rate of at least 30 g/10 minutes at 260° C., 2.16 kg load, according to ASTM D1238.

In some embodiments, the polymer composition has a melt flow rate of at least 30 g/10 minutes at 260° C., 2.16 kg load, according to ASTM D1238; and an Izod impact strength of at least about 90 J/m at 23° C., according to ASTM D256. This impact strength is acceptable for some applications.

The polymer composition may further comprise a salt-based flame retardant. The flame retardant may be a K, Na, or Li salt. Useful salt-based flame retardants include alkali metal or alkaline earth metal salts of inorganic protonic acids and organic Bronstëd acids comprising at least one carbon atom. These salts should not contain chlorine and/or bromine. Preferably, the salt-based flame retardants are sulfonates. In specific embodiments, the salt-based flame retardant is selected from the group consisting of potassium diphenylsulfon-3-sulfonate (KSS), potassium perfluorobutane sulfonate (Rimar salt), and combinations comprising at least one of the foregoing.

In some embodiments, the flame retardant polymer composition further comprises a polycarbonate-polysiloxane copolymer in addition to the polycarbonate blend.

The flame retardant polymer composition may also include various additives ordinarily incorporated in resin compositions of this type. Such additives include, for example, heat stabilizers; antioxidants; light stabilizers; plasticizers; antistatic agents; mold release agents; and blowing agents. Examples of heat stabilizers include triphenyl phosphite, tris-(2,6-dimethylphenyl)phosphite, tris-(2,4-di-t-butyl-phenyl)phosphite, tris-(mixed mono- and di-nonylphenyl)phosphite, dimethylbenzene phosphonate and trimethyl phosphate. Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Examples of light stabilizers include 2-(2-hydroxy-5-methylphenyl)benzotriazole, 2-(2-hydroxy-5-tert-octylphenyl)-benzotriazole and 2-hydroxy-4-n-octoxy benzophenone. Examples of plasticizers include dioctyl-4,5-epoxy-hexahydrophthalate, tris-(octoxycarbonylethyl)isocyanurate, tristearin and epoxidized soybean oil. Examples of antistatic agents include glycerol monostearate, sodium stearyl sulfonate, and sodium dodecylbenzenesulfonate. Examples of mold releasing agents include pentaerythritol tetrastearate, stearyl stearate, beeswax, montan wax and paraffin wax.

Colorants may be added if desired. These include pigments, dyes, and quantum dots. The amount may vary as needed to achieve the desired color.

UV absorbers may be used. Exemplary UV absorbers include hydroxybenzophenones; hydroxybenzotriazoles; hydroxybenzotriazines; cyanoacrylates; oxanilides; benzoxazinones; or the like, or combinations comprising at least one of the foregoing UV absorbers.

Anti-drip agents may be included. Anti-drip agents may be, for example, a fibril forming or non-fibril forming fluoropolymer such as polytetrafluoroethylene (PTFE). The anti-drip agent may be encapsulated by a rigid copolymer as described above, for example styrene-acrylonitrile copolymer (SAN). PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. A useful TSAN may comprise, for example, 50 wt % PTFE and 50 wt % SAN, based on the total weight of the encapsulated fluoropolymer. The SAN may comprise, for example, 75 wt % styrene and 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer.

Combinations of any of the foregoing additives may be used. Such additives may be mixed at a suitable time during the mixing of the components for forming the composition.

The flame retardant polymer compositions of the present disclosure may be formed into articles by conventional plastic processing techniques. Molded articles may be made by compression molding, blow molding, injection molding or such molding techniques known to those skilled in the art. Such articles may include, but are not limited to, film, sheet, pipes, tubes, profiles, molded articles, performs, stretch blow molded films and containers, injection blow molded containers, extrusion blow molded films and containers, thermoformed articles and the like. Articles prepared from the compositions of the present disclosure may be used in applications that require high flame retardance with good impact strength, such as automotive applications.

Generally, the flame retardant polymer compositions of the present disclosure will not be in the form of nanocomposites. The filler tends to agglomerate, such that the degree of dispersion needed for intercalation or exfoliation of the filler into the polymer matrix is not achieved.

The following examples are provided to illustrate the polymer compositions and methods of the present disclosure. The examples are merely illustrative and are not intended to limit the disclosure to the materials, conditions, or process parameters set forth therein.

### EXAMPLES

### Procedure

Flammability tests were performed following the procedure of Underwriter's Laboratory Bulletin 94 entitled “Tests for Flammability of Plastic Materials, UL94”, which is incorporated herein by reference. According to this procedure, the materials were classified as either UL94 V0, UL94 V1 or UL94 V2 on the basis of the test results obtained for five samples. The procedure and criteria for each of these flammability classifications according to UL94, are, briefly, as follows:

Procedure: A total of 10 specimens (2 sets of 5) are tested per thickness. Five of each thickness are tested after conditioning for 48 hours at 23° C., 50% relative humidity. The other five of each thickness are tested after conditioning for seven days at 70° C. The bar is mounted with the long axis vertical for flammability testing. The specimen is supported such that its lower end is 9.5 mm above the Bunsen burner tube. A blue 19 mm high flame is applied to the center of the lower edge of the specimen for 10 seconds. The time until the flaming of the bar ceases is recorded. If burning ceases, the flame is re-applied for an additional 10 seconds. Again, the time until the flaming of the bar ceases is recorded. If the specimen drips particles, these shall be allowed to fall onto a layer of untreated surgical cotton placed 305 mm below the specimen.

Criteria for flammability classifications according to UL94:

| | V0 | V1 | V2 |
|---|---|---|---|
| Individual flame time (sec) | ≦10 | ≦30 | ≦30 |
| Total flame time of 5 specimens (sec) | ≦50 | ≦250 | ≦250 |
| Glowing time of individual specimens (sec) | ≦30 | ≦60 | ≦60 |
| Particles ignite cotton? | No | No | Yes |

The flame out times from one set of ten bars (10 bars total at each thickness tested) were used to generate a p(FTP) value. The p(FTP) value is a statistical evaluation of the robustness of UL94 V0 or V1 performance. When the p(FTP) value is one or nearly one, the material is expected to consistently meet the UL94 V0 or V1 rating.

The time-to-drip, 5TTD, was measured using the following procedure. A specimen was clamped from the upper 6 mm of the specimen, with the longitudinal axis vertical. A flame was then applied to the specimen. The overall height of the flame was adjusted to approximately 125±10 mm, and the height of the inner blue cone was adjusted to 40±2 mm. The flame was applied for 5±0.5 seconds and then removed for 5±0.5 seconds. This was repeated until the specimen dripped. The total amount of time was recorded as the 5TTD.

The UL94 5VB performance was tested according to the following procedure: a flame was applied to a vertically fastened, 5-inch (127 mm) by 0.5-inch (12.7 mm) test bar of a given thickness above a dry, absorbent cotton pad located 12 inches (305 mm) below the bar. The thickness of the test bar was determined using calipers with 0.1 mm accuracy. The flame was a 5-inch (127 mm) flame with an inner blue cone of 1.58 inches (40 mm). The flame was applied to the test bar for 5 seconds so that the tip of the blue cone touched the lower corner of the specimen. The flame was then removed for 5 seconds. Application and removal of the flame was repeated until the specimen had five applications of the same flame. After the fifth application of the flame was removed, a timer (T-0) was started and the time that the specimen continued to flame (after-flame time), as well as any time the specimen continued to glow after the after-flame went out (after-glow time), was measured by stopping T-0 when the after-flame stopped, unless there was an after-glow and then T-0 was stopped when the after-glow stopped. The combined after-flame and after-glow time must be less than or equal to 60 seconds after five applications of a flame to a test bar, and there may be no drips that ignite the cotton pad, to achieve the 5VB standard. The test was repeated on 5 identical bar specimens. If there was a single specimen of the five that did not comply with the time and/or no-drip requirements, then a second set of 5 specimens was tested in the same fashion. All of the specimens in the second set of 5 specimens had to comply with the requirements in order for material at the given thickness to achieve the 5VB standard. 5VB results are reported here as either Pass/Fail or in seconds (combined after-flame and after-glow time).

The 5TTD test and 5VB test differed in that 5VB only requires five flame applications, then a measurement of after-flame and after-glow time. Under 5VB, the specimen might not drip. By contrast, 5TTD had no limit on the number of flame applications and flame was applied until the specimen began to drip.

Mechanical properties were measured according to the following ASTM or ISO standards, as indicated:

| | Standards | Testing Conditions |
|---|---|---|
| Melt Flow Rate | ASTM D1238 | 260° C., 2.16 kg |
| Flexural Modulus | ASTM D790 | |
| Charpy Impact | ISO 179/1eA | |
| Strength | | |
| Notched Izod Impact | ASTM D256 | 23° C. |
| Strength | | |
| Notched Izod Impact | ISO 180/1A | |
| Strength | | |
| Heat Deflection | ASTM D648 | 1.82 MPa, 6.4 mm |
| Temperature | | thickness |

It was noted in the Notched Izod Impact measurements whether the failure mode was brittle or ductile in nature. Brittle failure meant that the molded bar completely broke into unconnected pieces in the test, and ductile failure meant that the pieces of the molded bar remained connected after the test. The % ductility was calculated by dividing the number of bars of that sample that underwent ductile failure by the total number of bars of that sample tested.

The Examples discussed herein used the following ingredients in their compositions:

| Ingredient | Description |
|---|---|
| antioxidant | hindered phenol |
| BPADP | bisphenol-A bis(diphenyl phosphate), a flame retardant agent |
| Bulk ABS | Bulk ABS comprising about 17 wt. % polybutadiene |
| kaolin clay A | water washed kaolin clay having median particle size of 1.3 microns |
| kaolin clay B | water washed kaolin clay having median particle size of 0.4 microns |
| KSS | potassium diphenylsulfone sulfonated, salt-based flame retardant |
| MBS powder | an impact modifier having a butadiene core and a methacrylate/styrene shell |
| NaTS | sodium p-toluene sulfonate, salt-based flame retardant |
| PC-1 | a high flow Bisphenol-A polycarbonate homopolymer with a target molecular weight of |
| | 21,900 (based on GPC using polycarbonate standards) |
| PC-2 | a low flow Bisphenol-A polycarbonate homopolymer with a target molecular weight of |
| | 29,900 (based on GPC using polycarbonate standards) |
| PC-3 | High molecular weight polycarbonate made via melt extrusion process having a target |
| | molecular weight of 22,500 (based on GPC using polycarbonate standards) |
| PC-4 | low molecular weight polycarbonate made via melt extrusion process having a target |
| | molecular weight of 30,500 (based on GPC using polycarbonate standards) |
| PC-5 | High flow bisphenol-A polycarbonate homopolymer with a target molecular weight of |
| | 21,900 (based on GPC using polycarbonate standards) |
| PC-6 | Masterbatch of 25% BPADP and 75% PC-4 |
| PC-Si | a polycarbonate-polysiloxane copolymer comprising about 20% by weight of siloxane |
| PETS | pentaerythritol tetrastearate, a mold release agent |
| phosphite | stabilizer |
| SAN | High flow SAN having about 27% acrylonitrile, MFR (220° C./5 kg) of 14 to 20 g/10 min. |
| talc | filler, having median particle size of about 1.0 to about 1.3 microns |
| THPE/HBN | nitrile-capped polycarbonate having a target molecular weight of 28,400 Daltons (based |
| | on GPC using polycarbonate standards), THPE as the branching agent (having |
| | approximately 3 mole % THPE, 9.5 mole % HBN) |
| TSAN | polytetrafluoroethylene encapsulated in styrene-acrylonitrile copolymer, an anti-drip agent |

### Example 1

Two control compositions C1-C2 and three test compositions T1-T3 were made to test the effect of low levels of filler on the flame performance. The ingredients were pre-blended, then extruded and molded under normal processing conditions. The filler used was water washed kaolin clay with particle size of 1.3 microns.

The FOT 5 value referred to the flame out time for 5 specimens. The drips value referred to the number of specimens that dripped. The 5TTD was the time to drip. The 5TTD was measured in seconds; the higher the time, the better. The FOT2 refers to the Flame Out Time after the 2nd ignition; the lower the FOT2, the better. The HDT was the heat deflection temperature measured according to ASTM D648 at 1.82 MPa and 6.4 mm thickness.

The Spiral Flow indicated how well the material flowed in a spiral-shaped tool; the higher the value, the better it flowed. Spiral flow testing was performed according to the following procedure: A molding machine with a barrel capacity of 3 to 5 ounces (85 to 140 g) and channel depths of approximately 0.03, 0.06, 0.09, or 0.12 inches (0.76, 1.52, 2.29, or 3.05 millimeters, respectively) was loaded with pelletized thermoplastic composition. The mold and barrel were heated to a temperature suitable to flow the polymer, typically 240 to 330° C. The thermoplastic composition, after melting and temperature equilibration, was injected into the selected channel of the mold at 1500 psi (10.34 MPa) for a minimum flow time of 6 seconds, at a rate of 6.0 inches (15.24 cm) per second, to allow for maximum flow prior to gate freeze. Successive samples were generated using a total molding cycle time of 35 seconds. Samples were retained for measurement either after 10 runs were completed, or when successively prepared samples were of consistent size. Five samples were then collected and measured to within the nearest 0.25 inches (0.64 cm), and a median length for the five samples was reported. As reported herein, spiral flow was determined at 260° C., 2-second injection, with 2.0 mm wall thickness.

Results are shown in Table 1 below:

TABLE 1

| Description | Unit | C1 | C2 | T1 | T2 | T3 |
|---|---|---|---|---|---|---|
| PC-1 | % | 35.44 | 48.84 | 48.59 | 48.34 | 47.84 |
| PC-2 | % | 35.25 | 20.85 | 20.6 | 20.35 | 19.85 |
| ABS | % | 17 | 15 | 15 | 15 | 15 |
| BPADP | % | 11 | 12 | 12 | 12 | 12 |
| MBS Powder | % | | 2 | 2 | 2 | 2 |
| kaolin clay A | % | | | 0.5 | 1 | 2 |
| TSAN | % | 0.65 | 0.65 | 0.65 | 0.65 | 0.65 |
| PETS | % | 0.5 | 0.5 | 0.5 | 0.5 | 0.5 |
| phosphite | % | 0.08 | 0.08 | 0.08 | 0.08 | 0.08 |
| antioxidant | % | 0.08 | 0.08 | 0.08 | 0.08 | 0.08 |
| MFR | g/10 min | 17.9 | 26.0 | 24.7 | 23.9 | 22.9 |
| App. Viscosity @ | Pa · sec | 152.6 | 134.9 | 137.4 | 141.1 | 142.7 |
| 260° C., 1500 sec⁻¹ | | | | | | |
| Spiral Flow, | cm | 55.4 | 60.4 | 60.0 | 60.8 | 61.0 |
| 260° C./65° C. | | | | | | |
| Charpy Impact Strength | kJ/m² | 35.13 | 47.67 | 46.54 | 45.31 | 42.86 |
| Ductility | % | 100 | 100 | 100 | 100 | 100 |
| Impact Strength | J/m | 655 | 645 | 669 | 661 | 679 |
| (ASTM D256) | | | | | | |
| Ductility | % | 100 | 100 | 100 | 100 | 100 |
| Impact Strength | kJ/m² | 35.85 | 42.34 | 43.16 | 40.22 | 37.07 |
| (ISO 180) | | | | | | |
| Ductility | % | 100 | 100 | 100 | 100 | 100 |
| Flexural Modulus | MPa | 2380 | 2450 | 2530 | 2550 | 2600 |
| Flexural Stress @ Yield | MPa | 98 | 96 | 96 | 98 | 99 |
| HDT | ° C. | 90 | 86 | 89 | 86 | 88 |
| V0 @ 1.5 mm | p(FTP) | 0.64 | | | 0.70 | 1.00 |
| | drips | 0 | 1 | 1 | 0 | 0 |
| | FOT2 (sec) | 4.9 | | | 4.2 | 2.0 |
| 5TTD @ 2 mm | sec | 64.7 | 61.1 | 63.6 | 63.6 | 72.6 |

The results showed that as the amount of kaolin clay increased up to about 2 wt. %, the p(FTP) also improved, i.e. V0 performance at 1.5 mm was obtained. In addition, the 5TTD value increased. This improvement in flame retardance occurred together with retention of mechanical properties; the MVR, Charpy impact strength, Notched Izod impact strength, and/or flexural modulus of T1-T3 were all maintained or improved compared to C2.

### Example 2

Five control compositions C4-C8 and three test compositions T4-T6 were formulated and tested. As the filler, fine talc and clay were used. The fine talc had a median particle size of 1.0 to 1.3 microns. The kaolin clay was water-washed and had a median particle size of 0.4 microns. Results are shown in Table 2 below:

TABLE 2

| Description | Unit | C4 | C5 | T4 | T5 | C6 | C7 | C8 | T6 |
|---|---|---|---|---|---|---|---|---|---|
| PC-1 | % | 46.65 | 47.3 | 40.48 | 40.48 | 44.44 | 38 | 38 | 37.8 |
| PC-2 | % | 24.04 | 20.3 | 20.86 | 22.86 | 22.9 | 23 | 23 | 22 |
| PC-Si | % | | 7.5 | 3 | 3 | 1 | | 3 | 3 |
| ABS | % | 17 | 11.5 | 15 | 15 | 15 | 12.5 | 12.5 | 12.5 |
| BPADP | % | 11 | 12.25 | 15 | 15 | 14 | 16 | 16 | 16 |
| MBS Powder | % | | | 1 | 1 | 1 | 2 | 1 | 1 |
| SAN | % | | | | | | 7 | 5 | 5 |
| Fine talc | % | | | | | | | | 1 |
| kaolin clay B | % | | | 3 | 1 | | | | |
| PETS | % | 0.50 | 0.3 | 0.5 | 0.5 | 0.5 | 0.5 | 0.5 | 0.5 |
| TSAN | % | 0.65 | 0.75 | 1 | 1 | 1 | 0.85 | | 1 |
| phosphite | % | 0.08 | 0.08 | 0.08 | 0.08 | 0.08 | 0.08 | 0.08 | 0.08 |
| anti-oxidant | % | 0.08 | 0.08 | 0.08 | 0.08 | 0.08 | 0.08 | 0.08 | 0.08 |
| MFR (260° C., 2.16 kg) | g/10 min | 20.6 | 21 | 19 | 21 | 23 | 32 | 28 | 32 |
| Spiral Flow (260° C., 2.0 mm) | cm | 46.9 | 54.5 | 56.1 | 69.2 | 52.0 | 76.0 | — | 74.8 |
| HDT (1.82 MPa, 6.4 mm) | ° C. | 92 | 90 | 82 | 83 | 87 | 81 | 81 | 83 |
| Notched IZOD (23° C.) | J/m | 600 | 600 | 214 | 524 | 440 | 90 | 105 | 90 |
| (ASTM D256) | | | | | | | | | |
| V0 @ 1.5 mm | p(FTP) | 1 | 1 | 1 | 1 | 0.96 | 1 | 0.14 | 1 |
| 5TTD @ 1.5 mm | sec | 57 | <65 | 100 | 76 | 50 | — | — | 53 |
| 5TTD @ 1.8 mm | sec | 60 | >65 | 100 | 85 | 64 | <50 | <57 | 76 |

The results showed that the use of low loadings (3% or less) of clay or talc significantly improved the 5TTD of the compositions. C4, C5 and C6 were compared to T4 and T5. C7 and C8 were compared to T6. The increases of 5TTD at both 1.8 mm and 1.5 mm were significantly higher in the test compositions than the control compositions, while maintaining the MFR and Notched Izod Impact strength at similar levels or at acceptable levels for their corresponding applications. The higher the filler loading, the higher the 5TTD. T6 showed robust 5VB performance at 1.8 mm (5TTD>65 s) when the MFR was higher than 30. It was somewhat unexpected to achieve this combination, as it is usually difficult to attain the 5VB standard at a thickness of less than 2.0 mm with a high flow composition (MFR>25) due to severe dripping associated with high flow compositions. When filler was present, the MBS was necessary to keep the impact higher than 200 J/m.

### Example 3

Four control compositions C10-C13 and six test compositions T10-T15 were formulated. They were tested for V0 performance at three different thicknesses: 1.5 mm, 1.2 mm, and 1.0 mm. They were also tested for V1 performance at two thickness, 1.2 mm and 1.0 mm.

Results are shown in four ways. First, the p(FTP) was determined. The average FOT was the average flame out time over the samples: the lower, the better. The Max FOT was the maximum flame out time of the samples: the lower, the better. The SUM FOT2 was the sum of the flame out times after the 2^{nd} ignition for all samples: the lower the better. Results are listed in Table 3 below:

TABLE 3

| Description | Unit | C10 | C11 | T10 | C12 | T11 | C13 | T12 | T13 | T14 | T15 |
|---|---|---|---|---|---|---|---|---|---|---|---|
| THPE/HBN | % | 0 | 5 | 5 | 15 | 15 | 10 | 10 | 10 | 10 | 10 |
| PC-3 | % | 69.55 | 64.55 | 63.55 | 54.55 | 53.55 | 59.55 | 59.05 | 58.55 | 57.55 | 56.55 |
| PC-5 | % | 17.09 | 17.09 | 17.09 | 17.09 | 17.09 | 17.09 | 17.09 | 17.09 | 17.09 | 17.09 |
| PC-6 | % | 10 | 10 | 10 | 10 | 10 | 10 | 10 | 10 | 10 | 10 |
| MBS | % | 1.7 | 1.7 | 1.7 | 1.7 | 1.7 | 1.7 | 1.7 | 1.7 | 1.7 | 1.7 |
| powder | | | | | | | | | | | |
| kaolin clay B | % | | | 1 | | 1 | | 0.5 | 1 | 2 | 3 |
| PETS | % | 0.5 | 0.5 | 0.5 | 0.5 | 0.5 | 0.5 | 0.5 | 0.5 | 0.5 | 0.5 |
| TSAN | % | 1 | 1 | 1 | 1 | 1 | 1 | 1 | 1 | 1 | 1 |
| phosphite | % | 0.08 | 0.08 | 0.08 | 0.08 | 0.08 | 0.08 | 0.08 | 0.08 | 0.08 | 0.08 |
| antioxidant | % | 0.08 | 0.08 | 0.08 | 0.08 | 0.08 | 0.08 | 0.08 | 0.08 | 0.08 | 0.08 |
| UL 94V @ | Average | 1.3 | 1.3 | 0.8 | 1.5 | 1.0 | 1.2 | 1.3 | 1.0 | 1.0 | 0.9 |
| 1.5 mm | FOT | | | | | | | | | | |
| | MAX | 5.9 | 4.9 | 1.0 | 7.9 | 1.8 | 4 | 6.9 | 3 | 1.3 | 1.5 |
| | FOT | | | | | | | | | | |
| | SUM | 17.3 | 16.9 | 9.2 | 21.4 | 11.5 | 15.4 | 17.5 | 11.7 | 10.5 | 9.7 |
| | FOT2 | | | | | | | | | | |
| | p(FTP) | 0.997 | 0.999 | 1.000 | 0.993 | 1.000 | 1.000 | 0.993 | 1.000 | 1.000 | 1.000 |
| | V0 | | | | | | | | | | |
| UL 94V @ | Average | 3.5 | 2.5 | 2.3 | 3.6 | 2.3 | 2.1 | 3.2 | 1.0 | 1.6 | 2.1 |
| 1.2 mm | FOT | | | | | | | | | | |
| | MAX | 16.4 | 9.7 | 8.2 | 18.8 | 10.7 | 7.1 | 11.7 | 2 | 13.2 | 13.2 |
| | FOT | | | | | | | | | | |
| | SUM | 60.8 | 40.9 | 36.0 | 62 | 36.5 | 34.3 | 54.6 | 12.2 | 24 | 32.8 |
| | FOT2 | | | | | | | | | | |
| | p(FTP) | 0.315 | 0.660 | 0.727 | 0.300 | 0.673 | 0.764 | 0.321 | 1.000 | 0.958 | 0.789 |
| | V0 | | | | | | | | | | |
| | p(FTP) | 0.884 | 0.982 | 0.988 | 0.863 | 0.972 | 0.991 | 0.892 | 1.000 | 1.000 | 0.988 |
| | V1 | | | | | | | | | | |
| UL 94V @ | Average | 4.9 | 7.0 | 6.3 | 9.7 | 6.2 | 7.9 | 5.2 | 5.8 | 5.2 | 7.8 |
| 1.0 mm | FOT | | | | | | | | | | |
| | MAX | 23.7 | 28.8 | 29.4 | 33 | 19.8 | 24.6 | 17.8 | 29.1 | 16.2 | 26.2 |
| | FOT | | | | | | | | | | |
| | SUM | 89.1 | 129.9 | 117.7 | 184.8 | 116.3 | 147.9 | 95 | 107.1 | 95.4 | 147.1 |
| | FOT2 | | | | | | | | | | |
| | p(FTP) | 0.099 | 0.020 | 0.035 | 0.000 | 0.012 | 0.002 | 0.046 | 0.040 | 0.040 | 0.001 |
| | V0 | | | | | | | | | | |
| | p(FTP) | 0.752 | 0.505 | 0.539 | 0.374 | 0.691 | 0.438 | 0.752 | 0.537 | 0.914 | 0.522 |
| | V1 | | | | | | | | | | |

The results generally showed that the addition of clay increased the flame retardance of the composition.

### Example 4

One control composition C16 and one test composition T16 were formulated. These compositions included salt-based flame retardants potassium diphenylsulfone sulfonate (KSS) and sodium p-toluene sulfonate (NaTS). Results are shown in Table 4 below:

TABLE 4

| Description | Unit | C16 | T16 |
|---|---|---|---|
| PC-4 | % | 29.53 | 29.03 |
| PC-3 | % | 44.55 | 44.05 |
| PC-2 | % | 20 | 20 |
| Kaolin clay B | % | | 1 |
| BPADP | % | 2.5 | 2.5 |
| MBS Powder | % | 1.7 | 1.7 |
| PETS | % | 0.5 | 0.5 |
| TSAN | % | 1 | 1 |
| antioxidant | % | 0.08 | 0.08 |
| phosphite | % | 0.08 | 0.08 |
| KSS | % | 0.01 | 0.01 |
| NaTS | % | 0.05 | 0.05 |
| HDT | ° C. | 120 | 121 |
| Impact Strength (ASTM D256) | J/m | 858 | 866 |
| Ductility | % | 100 | 100 |
| Impact Strength (ISO 180), 3 mm | kJ/m² | 65.3 | 67.0 |
| bar | | | |
| Ductility | % | 100 | 100 |
| MFR (260° C., 5 Kg) | g/10 min | 17.7 | 15.6 |
| V1 @ 1.0 mm | p(FTP) | 0.74 | 0.96 |
| | FOT2 (sec) | 10.8 | 6.6 |
| V0 @ 1.3 mm | p(FTP) | 0.04 | 1.00 |
| | FOT2 (sec) | 9.3 | 2.1 |
| V0 @ 1.5 mm | p(FTP) | 0.86 | 1.00 |
| | FOT2 (sec) | 4.1 | 1.6 |
| 5VB @ 2 mm | FOT (sec) | 17.8 | 5.6 |

The results showed that the test composition containing clay had better flame retardance than the control composition, as seen in the increased p(FTP) and decreased FOT2.

### Example 5

Nine control compositions and nine test compositions, numbered 20-28, were formulated containing various colorants to determine their effect on the flame retardance. The ingredients of each control composition are shown in Table 5. No salt-based flame retardants were used in these compositions.

TABLE 5
Each control composition contained

| Description | Unit | Amount |
|---|---|---|
| PC-5 | % | 17.09 |
| phosphite | % | 0.08 |
| antioxidant | % | 0.08 |
| PETS | % | 0.5 |
| TSAN | % | 1 |
| MBS Powder | % | 1.7 |
| PC-6 | % | 10 |
| PC-3 | % | 69.55 |

plus

| Colorant | Unit | 20 | 21 | 22 | 23 | 24 | 25 | 26 | 27 | 28 |
|---|---|---|---|---|---|---|---|---|---|---|
| TiO₂ | phr | | 11.11 | | | 1.5 | | | | |
| Pigment Black 7 | phr | | | 0.5 | 1.03 | 0.00195 | | | | |
| Solvent Red 135 | phr | | | | 1.03 | | | | | |
| Quinophthalone Yellow PY 138 | phr | | | | 1.03 | | | | | |
| Pigment Red 101 | phr | | | | | 0.006667 | | | | |
| Disperse Yellow 201 | phr | | | | | | 0.5 | | | |
| Pigment Green 7 | phr | | | | | | | 0.5 | | |
| Pigment Blue 15:4 | phr | | | | | | | | 0.5 | |
| Pigment blue 28 | phr | | | | | | | | | 0.5 |

The composition of the nine test compositions was identical to that of the nine control compositions, except that the test compositions used only 16.09% PC-5 and included 1% kaolin clay having median particle size of 0.4 microns (kaolin clay B).

The compositions were then tested for V0 and V1 performance at three thicknesses: 1.0 mm, 1.2 mm, and 1.5 mm. The results are listed in Table 6 below. The number at the top of the column indicates the composition, both control and test. Again, for max FOT and SUM FOT, a lower value is better. For UL rating, V0 is better than V1.

TABLE 6

| | | | | | | | | |
|---|---|---|---|---|---|---|---|---|
| 20 | 21 | 22 | 23 | 24 | 25 | 26 | 27 | 28 |

Control

| | | | | | | | | | |
|---|---|---|---|---|---|---|---|---|---|
| Thickness: 1.0 mm | | | | | | | | | |
| p(FTP) V0 | 0.000 | 0.038 | 0.013 | 0.734 | 0.010 | 0.000 | 0.000 | 0.009 | 0.000 |
| p(FTP) V1 | 0.625 | 0.243 | 0.401 | 0.990 | 0.548 | 0.000 | 0.780 | 0.101 | 0.000 |
| max FOT (sec) | 28.1 | 39.9 | 39.9 | 13.9 | 30.4 | 12.2 | 23.9 | 60.8 | 65 |
| SUM FOT (sec) | 82 | 78 | 78 | 24 | 73.5 | drips | 88 | drips | drips |
| UL rating | V1 | none | none | V1 | V1 | none | V1 | none | none |

Test (1% Clay)

| | | | | | | | | | |
|---|---|---|---|---|---|---|---|---|---|
| p(FTP) V0 | 0.259 | 0.000 | 0.505 | 0.962 | 0.000 | 0.099 | 0.005 | 0.477 | 0.007 |
| p(FTP) V1 | 0.995 | 0.000 | 0.981 | 1.000 | 0.297 | 0.968 | 1.000 | 0.937 | 0.440 |
| max FOT (sec) | 13.4 | 44.5 | 15.7 | 7.7 | 22.9 | 13.2 | 13.9 | 10.1 | 25.6 |
| SUM FOT (sec) | 41.1 | 99.7 | 30.4 | 16.5 | 75.8 | 46.3 | 55.9 | 28.5 | 56.7 |
| UL rating | V1 | none | V1 | V0 | V1/ | V1 | V1 | V0/ | V1/ |
| | | | | | none | | | V1 | none |

Control

| | | | | | | | | | |
|---|---|---|---|---|---|---|---|---|---|
| Thickness: 1.2 mm | | | | | | | | | |
| p(FTP) V0 | 0.212 | 0.051 | 0.856 | 0.843 | 0.063 | 0.013 | 0.575 | 0.741 | 0.000 |
| p(FTP) V1 | 0.868 | 0.753 | 0.997 | 0.997 | 0.726 | 0.030 | 0.967 | 0.999 | 0.348 |
| max FOT (sec) | 15.3 | 24.8 | 10.7 | 8.3 | 19.9 | 13.3 | 16.8 | 9.7 | 55.8 |
| SUM FOT (sec) | 38 | 57 | 20 | 21 | 51 | drips | 28 | 30 | 102 |
| UL rating | V1 | V1 | V1 | V0 | V1 | none | V1 | V0 | none |

Test (1% Clay)

| | | | | | | | | | |
|---|---|---|---|---|---|---|---|---|---|
| p(FTP) V0 | 0.860 | 0.051 | 0.999 | 0.999 | 0.768 | 0.292 | 0.549 | 0.654 | 0.104 |
| p(FTP) V1 | 0.994 | 0.817 | 1.000 | 1.000 | 0.991 | 0.909 | 0.974 | 0.999 | 0.784 |
| max FOT (sec) | 11.4 | 15.8 | 5.7 | 6.2 | 10.3 | 13.8 | 9.9 | 8.3 | 17.4 |
| SUM FOT (sec) | 18 | 51 | 12 | 13 | 24 | 35 | 28 | 23 | 45 |
| UL rating | V1 | V1 | V1 | V1 | V1 | V1 | V1 | V1 | V1 |

Control

| | | | | | | | | | |
|---|---|---|---|---|---|---|---|---|---|
| Thickness: 1.5 mm | | | | | | | | | |
| p(FTP) V0 | 0.991 | 0.989 | 1.000 | 1.000 | 1.000 | 1.000 | 1.000 | 1.000 | 0.982 |
| p(FTP) V1 | 1.000 | 1.000 | 1.000 | 1.000 | 1.000 | 1.000 | 1.000 | 1.000 | 1.000 |
| max FOT (sec) | 8.2 | 6.8 | 3.0 | 1.7 | 2.6 | 2.0 | 3.2 | 2 | 8 |
| SUM FOT (sec) | 28 | 27 | 23 | 20 | 24 | 22 | 29 | 24 | 37 |
| UL rating | V0 | V0 | V0 | V0 | V0 | V0 | V0 | V0 | V0 |

Test (1% Clay)

| | | | | | | | | | |
|---|---|---|---|---|---|---|---|---|---|
| p(FTP) V0 | 1.000 | 0.991 | 1.000 | 1.000 | 1.000 | 1.000 | 1.000 | 1.000 | 1.000 |
| p(FTP) V1 | 1.000 | 1.000 | 1.000 | 1.000 | 1.000 | 1.000 | 1.000 | 1.000 | 1.000 |
| max FOT (sec) | 3.9 | 9.5 | 1.3 | 1.3 | 1.3 | 2.5 | 1.0 | 1.6 | 3.1 |
| SUM FOT (sec) | 21 | 27 | 18 | 17 | 16 | 20 | 17 | 18 | 22 |
| UL rating | V0 | V0 | V0 | V0 | V0 | V0 | V0 | V0 | V0 |

The results showed that generally, a colorant can be used in the composition without affecting the improved flame retardance. Generally, the p(FTP) was the same as or better for the test compositions containing a small amount of clay.

### Example 6

One control composition C33 and two test compositions T33 and T34 were formulated and tested. Results are shown in Table 7 below:

TABLE 7

| Item Description | Unit | C33 | T33 | T34 |
|---|---|---|---|---|
| PC-4 | % | 29.59 | 29.59 | 29.59 |
| PC-3 | % | 44.55 | 44.05 | 43.55 |
| PC-2 | % | 20 | 20 | 20 |
| BPADP | % | 2.5 | 2.5 | 2.5 |
| MBS Powder | % | 1.7 | 1.7 | 1.7 |
| Kaolin clay B | % | | 0.5 | 1 |
| PETS | % | 0.5 | 0.5 | 0.5 |
| TSAN | % | 1 | 1 | 1 |
| antioxidant | % | 0.08 | 0.08 | 0.08 |
| phosphite | % | 0.08 | 0.08 | 0.08 |
| MVR (260° C., 5 Kg) | g/10 min | 18.2 | 17.4 | 16.3 |
| App. Viscosity | Pa · s | 474 | 486 | 482 |
| (260° C., 1500 sec⁻¹) | | | | |
| Impact Strength | J/m | 890 | 906 | 882 |
| (ASTM D256, 23° C.) | | | | |
| Impact Strength | J/m | 173 | 169 | 168 |
| (ASTM D256, −30° C.) | | | | |
| Impact Strength | kJ/m² | 69.5 | 71.0 | 72.0 |
| (ISO 180, 23° C., 3 mm bar) | | | | |
| Impact Strength | kJ/m² | 16.1 | 16.8 | 17.4 |
| (ISO 180, −30° C., 3 mm bar) | | | | |
| HDT | ° C. | 119 | 119 | 118 |
| V0 @ 1.0 mm | p (FTP) | 0.87 | 1.00 | 0.88 |
| V1 @ 1.0 mm | p (FTP) | 1.00 | 1.00 | 1.00 |
| | FOT2 (s) | 3.6 | 1.9 | 3.6 |
| V0 @ 1.3 mm | p (FTP) | 1.00 | 0.92 | 1.00 |
| | FOT2 (s) | 2.0 | 2.7 | 1.9 |
| V0 @ 1.5 mm | p (FTP) | 1.00 | 1.00 | 1.00 |
| | FOT2 (s) | 1.8 | 2.0 | 1.4 |
| 5VB @ 2.0 mm | FOT (s) | 6.2 | 3.0 | 4.6 |
| 5TTD @ 2.0 mm | sec | 73 | 97 | 98 |
| BPT value - Average | mm | 1.47 | 1.47 | 1.46 |

The BPT is a testing characteristic of heat resistance and was tested using the following procedure. First, an oven was calibrated and set to 125±2° C. A sample was placed onto a specimen support and a pressure ball was placed in the middle of the sample. The ball had a diameter of the ball of 5 mm and a total weight of 20 N. After 1 hour in the oven, the sample was rapidly cooled down (within 10 sec.) by immersing it in cold water. The sample was then dried and placed in a conditioned lab. An optical microscope was used to measure the diameter of the hole formed on the sample surface within 30 min of taking the sample out of the oven. If the deflection was less than 2 mm, then the sample passed the BPT test.

Again, the results showed that the addition of clay increased the flame retardance of the composition, without decreasing the mechanical properties.

### Example 7

Two control compositions C35 and C36 and six test compositions T35-T40 were made. The test compositions used kaolin and various metal oxide nanoparticles to determine their effect on the flame retardance. Results are shown in Table 8 below:

TABLE 8

| Description | Unit | C35 | C36 | T35 | T36 | T37 | T38 | T39 | T40 |
|---|---|---|---|---|---|---|---|---|---|
| PC-1 | % | 35.44 | 49 | 49 | 49 | 49 | 49 | 49 | 49 |
| PC-2 | % | 35.25 | 21 | 21 | 21 | 21 | 21 | 21 | 21 |
| Bulk ABS | % | 17 | 16 | 16 | 16 | 16 | 16 | 16 | 16 |
| MBS Powder | % | | 2 | 2 | 2 | 2 | 2 | 2 | 2 |
| BPADP | % | 11 | 12 | 12 | 12 | 12 | 12 | 12 | 12 |
| PETS | % | 0.5 | 0.5 | 0.5 | 0.5 | 0.5 | 0.5 | 0.5 | 0.5 |
| TSAN | % | 0.65 | 0.85 | 0.65 | 0.65 | 0.65 | 0.65 | 0.65 | 0.65 |
| phosphite | % | 0.08 | 0.08 | 0.08 | 0.08 | 0.08 | 0.08 | 0.08 | 0.08 |
| antioxidant | % | 0.08 | 0.08 | 0.08 | 0.08 | 0.08 | 0.08 | 0.08 | 0.08 |
| kaolin clay A | % | | | 1 | | | | | |
| nano-BaSO₄ | % | | | | 1 | | | | |
| SiO₂ 40 nm uncoated | % | | | | | 1 | | | |
| TiO₂, coated | % | | | | | | 1 | | |
| nano-Al₂O₃ | % | | | | | | | 1 | |
| nano-CaCO₃ | % | | | | | | | | 1 |
| MFR (260° C., 2.16 kg) | g/10 min | 19.2 | 22.8 | 23.2 | 24.4 | 24.9 | 25.9 | 24.5 | 39.2 |
| App. Viscosity, | Pa · sec | 141 | 139 | 139 | 139 | 136 | 135 | 138 | 115 |
| (260° C., 1500 sec⁻¹) | | | | | | | | | |
| Flexural Modulus | MPa | 2480 | 2420 | 2520 | 2530 | 2500 | 2520 | 2490 | 2480 |
| Flexural Stress @ | MPa | 97 | 95 | 97 | 98 | 96 | 94 | 96 | 96 |
| Yield | | | | | | | | | |
| HDT | ° C. | 91 | 89 | 89 | 89 | 89 | 89 | 89 | 88 |
| Impact Strength | J/m | 677 | 683 | 690 | 739 | 718 | 691 | 662 | 655 |
| (ASTM D256) | | | | | | | | | |
| Impact Strength | kJ/m² | 15.5 | 45.0 | 52.3 | 44.6 | 45.6 | 45.7 | 46.5 | 38.4 |
| (ISO 180) | | | | | | | | | |
| Impact Strength | kJ/m² | 16.7 | 49.1 | 51.9 | 49.5 | 49.9 | 50.3 | 51.9 | 42.9 |
| (ISO 179) | | | | | | | | | |
| 5TTD @ 2.0 mm | sec | 59.3 | 47.8 | 52.7 | 50.9 | 57.8 | 56.0 | 52.6 | 51.2 |
| V0 @ 1.5 mm | p(FTP) | 0.28 | — | 0.96 | — | — | — | 0.92 | — |
| | FOT2 | 6.6 | — | 2.8 | — | — | — | 4.0 | — |
| | (sec) | | | | | | | | |
| | drips | none | 1/10 | none | 1/10 | 2/10 | 2/10 | none | — |

The results showed that only kaolin and aluminum oxide nanoparticles improved the flame retardance. The other metal oxide nanoparticles allowed dripping, which did not occur with the two control compositions that contained no filler.

### Example 8

One control composition C41 and six test compositions T41-T46 were formulated. Results are shown in Table 9 below:

TABLE 9

| Description | Unit | C41 | T41 | T42 | T43 | T44 | T45 | T46 |
|---|---|---|---|---|---|---|---|---|
| PC-1 | % | 39.37 | 38.87 | 38.37 | 38.87 | 38.37 | 38.87 | 38.37 |
| PC-2 | % | 29.37 | 28.87 | 28.37 | 28.87 | 28.37 | 28.87 | 28.37 |
| PC-Si | % | 3 | 3 | 3 | 3 | 3 | 3 | 3 |
| Bulk ABS | % | 11.5 | 11.5 | 11.5 | 11.5 | 11.5 | 11.5 | 11.5 |
| MBS Powder | % | 2 | 2 | 2 | 2 | 2 | 2 | 2 |
| BPADP | % | 13.7 | 13.7 | 13.7 | 13.7 | 13.7 | 13.7 | 13.7 |
| PETS | % | 0.2 | 0.2 | 0.2 | 0.2 | 0.2 | 0.2 | 0.2 |
| TSAN | % | 0.7 | 0.7 | 0.7 | 0.7 | 0.7 | 0.7 | 0.7 |
| phosphite | % | 0.08 | 0.08 | 0.08 | 0.08 | 0.08 | 0.08 | 0.08 |
| antioxidant | % | 0.08 | 0.08 | 0.08 | 0.08 | 0.08 | 0.08 | 0.08 |
| kaolin clay A | % | | | | 1 | 2 | | |
| kaolin clay B | % | | 1 | 2 | | | | |
| Fine Talc | % | | | | | | 1 | 2 |
| MFR, 260° C., 2.16 kg | g/10 min | 25.3 | 23.6 | 23.9 | 23.5 | 22.7 | 25.7 | 24.0 |
| Spiral Flow, | cm | 53.1 | 53.2 | 53.7 | 52.5 | 53.2 | 55.1 | 55.4 |
| 260° C./65° C., 2 mm | | | | | | | | |
| Flexural Modulus | MPa | 2240 | 2320 | 2380 | 2330 | 2380 | 2370 | 2430 |
| Flexural | MPa | 93 | 94 | 94 | 93 | 94 | 92 | 89 |
| Stress @ Yield | | | | | | | | |
| HDT, 1.82 MPa, 6.4 mm | % | 85 | 89 | 88 | 88 | 89 | 88 | 85 |
| IZOD ASTM Impact | J/m | 795 | 791 | 724 | 751 | 692 | 683 | 509 |
| Strength, 23° C. | | | | | | | | |
| V0 @ 1.2 mm | p(FTP) | 0.92 | 1.00 | 1.00 | 1.00 | 1.00 | 0.99 | 1.00 |
| | FOT2 | 5.5 | 3.4 | 2.7 | 3.0 | 3.6 | 4.6 | 3.5 |
| | (sec) | | | | | | | |
| | drips | 0 | 0 | 0 | 0 | 0 | 0 | 0 |
| V0 @ 1 mm | p(FTP) | 0.00 | 0.97 | 0.98 | 1.00 | 1.00 | 0.99 | 1.00 |
| | FOT2 | 11.1 | 4.2 | 4.3 | 3.9 | 3.5 | 4.7 | 4.0 |
| | (sec) | | | | | | | |
| | drips | 2/10 | 0 | 0 | 0 | 0 | 0 | 0 |
| 5VB @ 1.5 mm | FOT | 8.6 | 8.1 | 6.7 | 6.3 | 6.1 | 6.8 | 4.4 |
| | (sec) | | | | | | | |
| | drips | 0 | 0 | 0 | 0 | 0 | 0 | 0 |
| 5TTD @ 1.5 mm | sec | 68.2 | 77.0 | 78.4 | 77.8 | 73.9 | 73.9 | 96.5 |

Again, the data showed improved flame retardance in the compositions using small amounts of filler, as indicated by the increased 5TTD and the decreased FOT2. The mechanical properties were maintained at the same time.

The polymer compositions of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A flame retardant polymer composition comprising:
a blend of a polycarbonate polymer and a butadiene-styrene based polymer; and
from about 0.5% to about 3% by weight of a filler, based on the total weight of the polymer composition;
wherein the filler is selected from the group consisting of a clay, talc, and aluminum oxide particles.

2. The polymer composition of claim 1, wherein the clay is kaolin clay.

3. The polymer composition of claim 1, wherein the polymer composition has an Izod impact strength of at least about 700 J/m at 23° C., according to ASTM D256.

4. The polymer composition of claim 1, wherein an article molded from the polymer composition can attain UL94 V0 performance at a thickness of 1.5 millimeters.

5. The polymer composition of claim 1, wherein an article molded from the polymer composition can attain UL94 V0 performance at a thickness of 1.2 millimeters.

6. The polymer composition of claim 1, wherein an article molded from the polymer composition can attain UL94 V0 performance at a thickness of 1.0 millimeters.

7. The polymer composition of claim 1, wherein the polymer composition has a melt flow rate of at least 20 g/10 minutes at 260° C., 2.16 kg load, according to ASTM D1238.

8. The polymer composition of claim 1, wherein the filler is present in an amount of from about 1% to about 2% by weight, based on the total weight of the polymer composition.

9. The polymer composition of claim 1, wherein the weight ratio of butadiene-styrene based polymer to polycarbonate polymer is from 1:99 to 20:80.

10. The polymer composition of claim 1, wherein the filler has a median particle size of from about 0.01 microns to about 2.0 microns.

11. The polymer composition of claim 1, wherein the filler has a median particle size of from about 0.4 microns to about 1.3 microns.

12. The polymer composition of claim 1, further comprising a salt-based flame retardant, a phosphorous-based flame retardant, or bisphenol-A bis(diphenyl phosphate).

13. The polymer composition of claim 1, further comprising a polycarbonate-polysiloxane copolymer.

14. The polymer composition of claim 1, wherein the butadiene-styrene based polymer is selected from the group consisting of an acrylonitrile-butadiene-styrene polymer, a methacrylate-butadiene-styrene polymer, and combinations thereof.

15. The polymer composition of claim 1, wherein an article molded from the polymer composition can attain UL94 5VB performance at a thickness of 1.5 millimeters; and the polymer composition has a melt flow rate of at least 20 g/10 minutes at 260° C., 2.16 kg load, according to ASTM D1238.

16. The polymer composition of claim 1, wherein an article molded from the polymer composition can attain UL94 V0 performance at a thickness of 1.2 millimeters and can attain UL94 5VB performance at a thickness of 2.0 millimeters; and the polymer composition has a heat deflection temperature of at least 115° C., according to ASTM D648.

17. The polymer composition of claim 1, wherein an article molded from the polymer composition can attain UL94 5VB performance at a thickness of 1.8 millimeters; and the polymer composition has a melt flow rate of at least 30 g/10 minutes at 260° C., 2.16 kg load, according to ASTM D1238.

18. A flame retardant polymer composition comprising:
a blend of a polycarbonate polymer and an impact modifier; and
from about 0.5% to about 3% by weight of a filler, based on the total weight of the polymer composition;
wherein the filler is selected from the group consisting of a clay, talc, and aluminum oxide particles; and
wherein the weight ratio of impact modifier to polycarbonate polymer is from 1:99 to 20:80.

19. An article molded from a flame retardant polymer composition, the polymer composition comprising:
a blend of a polycarbonate polymer and a butadiene-styrene based polymer; and
from about 0.5% to about 3% by weight of a filler, based on the total weight of the polymer composition;
wherein the filler is selected from the group consisting of a clay, talc, and aluminum oxide nanoparticles.

20. The article of claim 19, wherein the article can attain UL94 V0 performance at a thickness of 1.5 millimeters.

21. A method of making a flame retardant polymer composition, comprising:
providing a blend of a polycarbonate polymer and a butadiene-styrene based polymer; and
adding to the blend a filler selected from the group consisting of a clay, talc, and aluminum oxide nanoparticles, to form a polymer composition,
wherein the filler is added in the amount of from about 0.5% to about 3% by weight, based on the total weight of the polymer composition.
